(19) United States
(12) Patent Application Publication
(10) Pub. No.: US 2013/0091771 A1
(43) Pub. Date: Apr. 18, 2013

(54) Safety Moving Gate

(71) Applicant: Arash Shekari oreh, London (GB)

(72) Inventor: Arash Shekari oreh, London (GB)

(21) Appl. No.: 13/272,935

(22) Filed: Oct. 13, 2011

(51) Int. Cl. E06B 5/00; E05F 15/20; E05F 15/08

(52) U.S. Cl. 49/31; 49/358

(57) ABSTRACT

A safety moving gate is a multi functional system which can be a resistant and reliable handrail to provide safety for passengers and at the same time, while train stops in the platform the system act as a moving gate and pulls up the horizontal cables to clear the doorways and enable people to enter the train safely.

### TECHNICAL FIELD

The present invention, in some embodiments thereof, relates to safety handrails to protect passengers and prevent accidents on train platforms.

### BACKGROUND OF THE INVENTION

Train platforms typically comprise a waiting area in front of deep pit through which a train passes through a station. With no barrier to prevent falls, serious injury or death can occur.

It would therefore be advantageous to have, to have a safety feature on the platform. The present invention addresses this need.

### BRIEF SUMMARY OF EMBODIMENTS OF THE INVENTION

The present invention relates to a moving gate apparatus for a railway station platform comprising a gate formed of a series of horizontally extending guard members vertically displaceable between a lowermost position. The gate apparatus provides a barrier against passengers wishing to access a train adjacent the platform. An uppermost position allows access to a train, the displacement being provided by means driving vertical cables in loop form. Each loop has a lowermost pulley, mountable to the platform by adjustable means to tension the loop. An uppermost pulley is mountable on a suitable station structure. At least one of the uppermost pulleys is coupled to the driving means.

In a variant of the moving gate apparatus the driving means comprises one or more electromotors.

In another variant of the moving gate apparatus, the guard members are handrails.

In a further variant of the moving gate apparatus, the driving means is controlled by an operator or electronic eyes which can detect movements of trains relative to the platform.

In still another variant of the moving gate apparatus, the adjustable tension means is a bolt.

In another variant of the moving gate apparatus, the handrails are cables.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 depicts a conventional train platform without safety moving gate;

FIG. 2 depicts a cross section of floor connection;

FIG. 3 depicts a cross section of ceiling;

FIG. 4 depicts an installed safety moving gate in the platform; and

FIG. 5 illustrates the position of the gate when train has stopped in the platform and the gate is open to enable passengers to get into the train.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

The present invention relates to a safety handrail to protect passengers and prevent accidents in train platforms.

The performance of this invention is based on putting a ring of lifting cable under tension to create a resistant column and provide the needed resistance for the safety guard. By turning the ring and its attached horizontal axis, handrail moves and passengers can cross.

Using static metal column and using gravity and static calculation to build conventional handrails as safety guards would close crossing section to the train. Those designs are based on single strong joint between surface and main static columns, to be able to resist against weight and force. Mentioned conventional designs are used as permanent handrails and modifying them to be moveable, decreases the resistance and performance of the handrail.

Mentioned limitations of the implementation of a reliable safety guard which can operate as a moving gate at the same time to enable passenger to get into the train, is the aim of this invention. Considering current limitations, this invention operates as a reliable safety moving guard with minimum distractive effect on existing platforms.

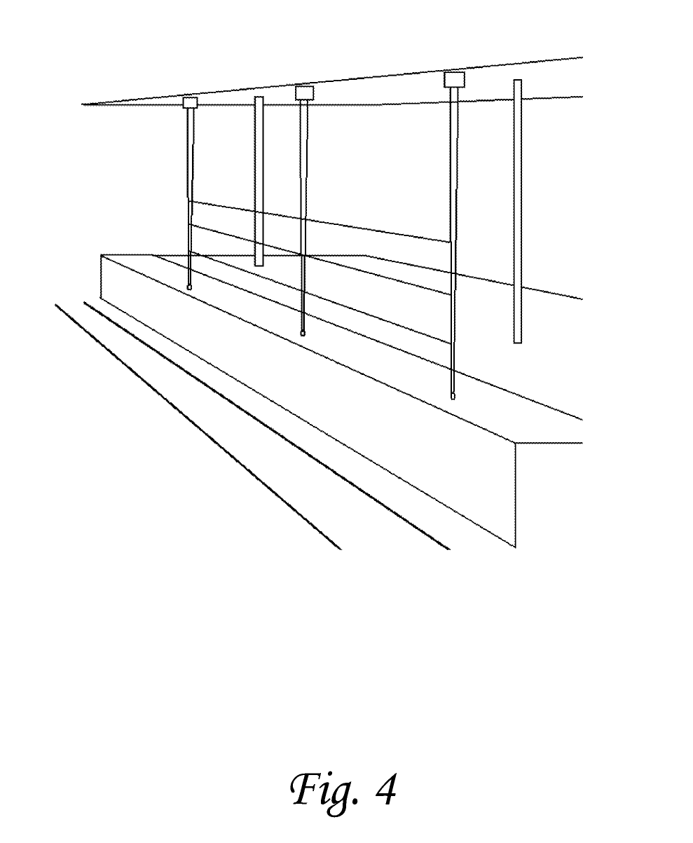

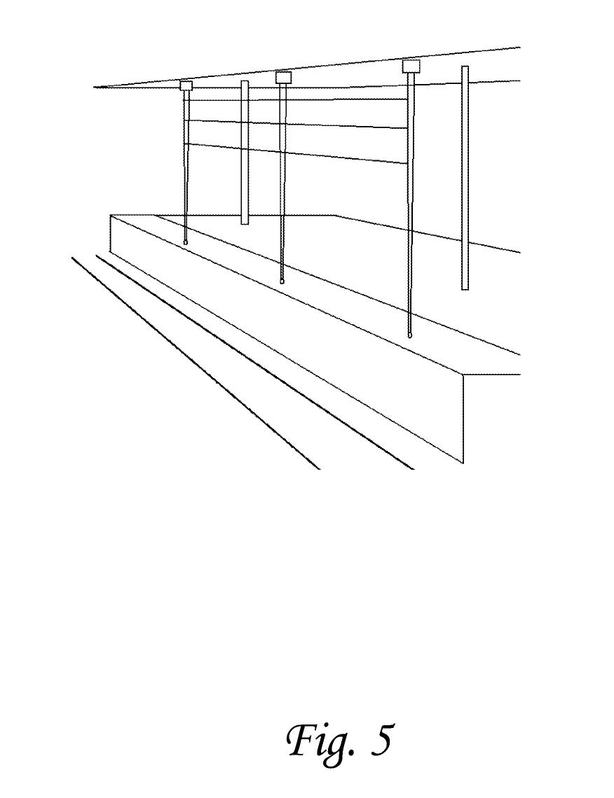

For the control purposes the safety guards will be connected to main control room or alternatively for train stations can be connected to two electronic eyes at two side of platform. Referring to FIG. 5, when the train enters to the platform, safety guards move up and when train stops, the doorways are clear. Referring to FIG. 4, when train starts to move second electronic eye activates the guard and move handrails in place.

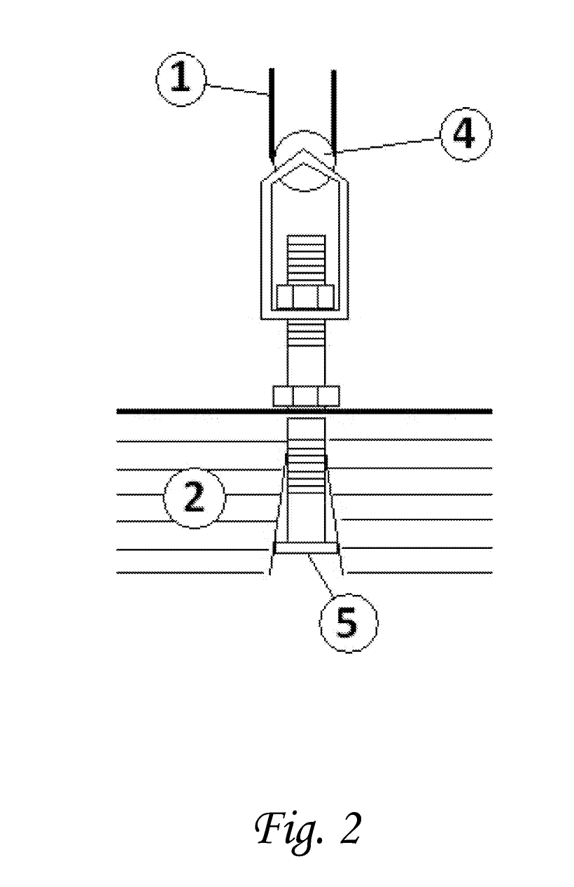

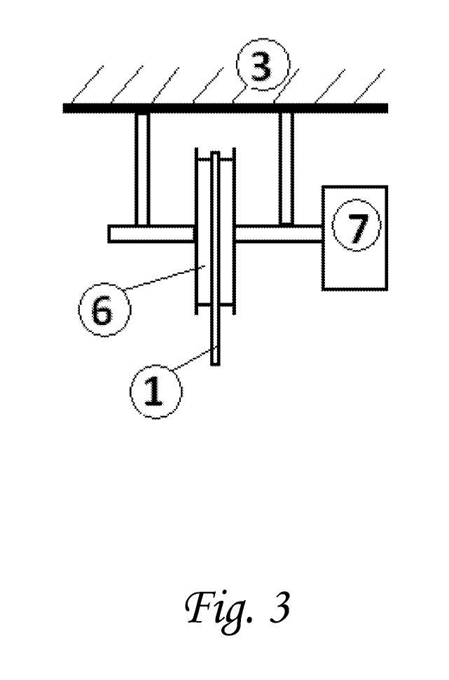

In this design the calculations of resistance forces are based on two connection points, one with floor (FIG. 2) and another one with ceiling (FIG. 3). The ceiling can be common hard material ceiling like concrete or steel, shelters or alternatively any extension from existing columns. For the connection point to the platform surface we will use expanding bolts connected to a pulley that works as rail for main connection cables. The expanded bolt resists against enormous amounts of force and the connection will never fail. An extension to the bolt is designed to adjust the elevation of the lower pulley to enforce the tension in the final system adjustment.

After installing surface and ceiling connections, the cable (1) sits on the pulleys and through adjusting the extension of the expanded bolt, the main cable goes under tension force. The vertical cables are connected with horizontal cables which are the main safety guards. By turning the ceiling pulley (6) with an electromotor (7), the tensioned cable turns and the safety guard moves up and enables passengers to cross over.

The rotary element can be an electromotor or a connection to main rotary beam, depending on existing elements on the platform or desired final design. Using one electromotor for each vertical column or using one for all of the columns, does not affect the performance of the system.

For the control purposes, the safety guards will be connected to a main control room or, alternatively for train stations, they can be connected to two electronic eyes at two sides of platform. When the train enters to the platform, safety guards move up and when train stops, the doorways are clear. When train starts to move second electronic eye activates the guard.

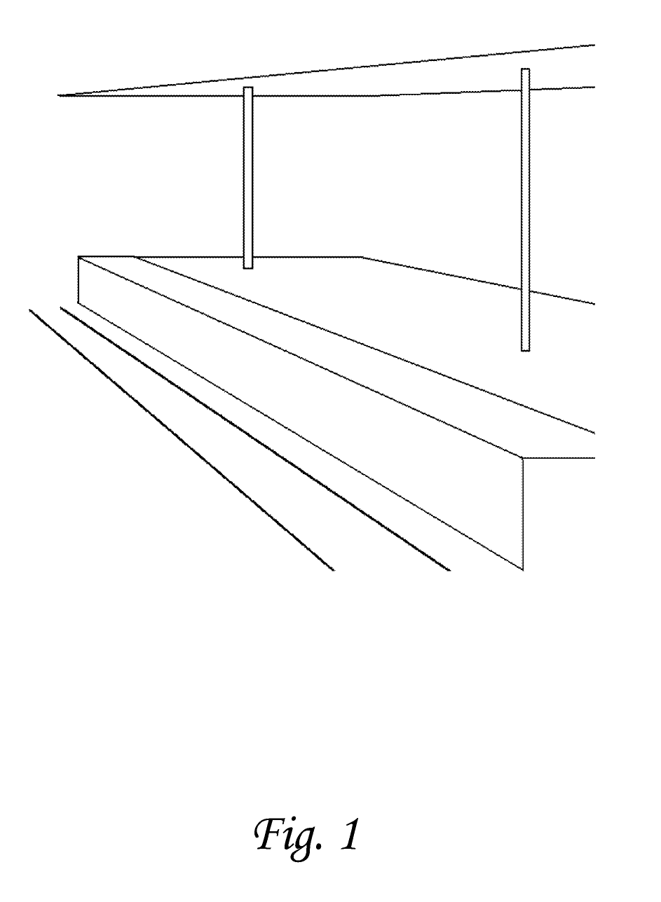

FIG. 1 shows a conventional train platform without safety moving gate.

FIG. 2 shows a cross section of floor connection which is a expanding bolt (5) in concrete (2), connected to lower pulley (4) to hold the lifting cable (1) and through adjusting the elevation of pulley force the tension on the cable.

FIG. 3 shows a cross section of ceiling (3) connection which contains a base plate to connect upper pulley (6) and electromotor (7).

FIG. 4 shows an installed safety moving gate in the platform. In this figure horizontal cables are in lower position and protecting passenger and the gate is closed.

FIG. 5 shows the position of the gate when train has stopped in the platform and the gate is open to enable passengers to get into the train.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A moving gate apparatus for a railway station platform for providing a barrier against passengers wishing to access a train adjacent the platform, comprising:
a gate formed of a series of horizontally extending guard members vertically displaceable between a lowermost position, and an uppermost position, for allowing access to a train;
the displacement being provided by means driving vertical cables in loop form;
each loop having a lowermost pulley, mountable to the platform by adjustable means to tension the loop; and
an uppermost pulley, mountable on a suitable station structure;
wherein at least one of the uppermost pulleys being coupled to the driving means.

2. The moving gate apparatus of claim 1, wherein the driving means comprise one or more electromotors.

3. The moving gate apparatus of claim 1, wherein the guard members are handrails.

4. The moving gate apparatus of claim 1 wherein the driving means is controlled by an operator or electronic eyes which can detect movements of trains relative to the platform.

5. The moving gate apparatus of claim 1, wherein the adjustable tension means is a bolt.

6. The moving gate apparatus of claim 3, wherein the handrails are cables.
